(19) United States
(12) Patent Application Publication
(10) Pub. No.: US 2025/0239888 A1
(43) Pub. Date: Jul. 24, 2025

(54) HIGH EFFICIENCY FAR-FIELD MILLIMETER WAVE-BASED WIRELESS POWER TRANSFER SYSTEM USING CU/CO METACONDUCTOR

(71) Applicant: University of Florida Research Foundation, Inc., Gainesville, FL (US)

(72) Inventors: Yong Kyu Yoon, Gainesville, FL (US); Woosol Lee, Gainesville, FL (US); Hanna Jang, Gainesville, FL (US)

(21) Appl. No.: 19/015,517

(22) Filed: Jan. 9, 2025

Related U.S. Application Data
(60) Provisional application No. 63/623,619, filed on Jan. 22, 2024.

(51) Int. Cl. H02J 50/23; H01Q 21/06; H02J 50/27

(52) U.S. Cl. CPC H02J 50/23; H01Q 21/065; H02J 50/27

(57) ABSTRACT

The present disclosure presents wireless power transfer systems and related methods. One such system comprises a transmitter antenna configured to transmit a radiative power signal; a receiver antenna configured to capture the transmitted radiative power signal; and a rectifier circuit coupled to the receiver antenna and configured to convert the captured radiative power signal to DC power. Accordingly, the transmitter antenna, the receiver antenna, and the rectifier circuit are each formed of a combination of ferromagnetic and non-ferromagnetic conductors in alternating multilayers

### CROSS-REFERENCE TO RELATED APPLICATION

This application claims priority to co-pending U.S. provisional application entitled, “High Efficiency Far-Field Milimeter Wave-Based Wireless Power Transfer System Using Cu/Co Metaconductor,” having application No. 63/623,619, filed Jan. 22, 2024, which is entirely incorporated herein by reference.

### STATEMENT REGARDING FEDERALLY SPONSORED RESEARCH OR DEVELOPMENT

This invention was made with government support under 2235978 awarded by the National Science Foundation. The government has certain rights in the invention.

### BACKGROUND

Currently, wireless power transfer (WPT) solutions, mostly based on inductive coupling, are already commercially available. However, most of the existing WPT systems have limited power transfer distance as they take the inductive coupling approach, where the power transfer efficiency (PTE) rapidly decreases as the distance between transmitter (Tx) and receiver (Rx) coils increases. An alternative is to utilize a far-field radiative WPT approach with a rectenna (antenna+rectifier), which can extend the transfer distance to the meters ˜ kilometers range. However, the current end-to-end efficiency of radiative far-field WPT systems using state-of-the-art (SOA) component technologies is reported to be between 3-5% which greatly limits the practical implementation of radiative WPT systems.

Millimeter wave (mmWave)-based WPT can also be considered. As its wavelength is small (˜ mm), the corresponding antenna size can be reduced. It can also be less dispersive, and its beam directivity can be high, and thus, the path loss can be lowered. However, a limiting factor in the use of mmWave for WPT is the significantly high RF conductor loss associated with the skin effect, the tendency of current to flow in the outermost layer of the conductor due to induced eddy current at the high frequency.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a block diagram of a radiative wireless power transfer (WPT) system in accordance with the present disclosure.

FIG. 2 shows a chart depicting a skin depth of a copper wire on a logarithmic scale.

FIGS. 3A-3C show schematics and current distributions of (a) a normal conductor at DC, (b) normal conductor at frequency f, and (c) metaconductor (MC) at frequency f, in accordance with the present disclosure.

FIG. 4 shows a schematic of an exemplary MC-based WPT system in accordance with various embodiments of the present disclosure.

FIGS. 5A-5B show top and side views of exemplary schematic diagrams of transmitter (Tx) and receiver (Rx) antennas of an exemplary MC-based WPT system in accordance with various embodiments of the present disclosure.

FIG. 6 shows simulated results of the Tx and Rx antennas of FIG. 5A.

FIGS. 7A-7B show simulated radiation patterns of the Tx and Rx antennas of FIG. 5A for the (a) YZ plane and (b) XZ plane.

FIG. 8 shows a block diagram of an exemplary rectifier circuit of the MC-based WPT system of FIG. 4.

FIG. 9 shows a schematic of a rectifier circuit that is used to investigate the effect of the metaconductor (MC) on the rectifier performance.

FIGS. 10A-10B is an image of a fabricated prototype of the MC-based WPT system for (a) Tx or Rx antenna, and (b) Rectifier circuit.

FIG. 10C shows an exemplary fabrication process of the prototypes of FIGS. 10A-10B.

FIG. 11 shows a scanning electron microscope image of a cross section view of the fabricated Cu/Co MC material for the MC-based WPT system in accordance with various embodiments of the present disclosure.

FIG. 12 shows Tx and Rx S11 measurements for an exemplary MC-based WPT system in accordance with the present disclosure.

FIGS. 13A and 13B shows measurement setups for measuring efficiencies of the Cu and Cu/Co MC-based WPT systems and Cu/Co MC-based rectifier circuits using a vector network analyzer.

FIG. 14 shows S21 measurements of Cu and Cu/Co MC-based WPT systems in accordance with the present disclosure.

FIGS. 15A-15B show S21 measurements and transfer efficiencies of Cu and Cu/Co MC-based WPT systems in accordance with the present disclosure.

FIG. 16 shows simulated and measured S11 values of Cu and Cu/Co MC-based rectifier circuits in accordance with the present disclosure.

FIG. 17 shows simulated and measured RF-to-DC conversion efficiencies of Cu and Cu/Co MC-based rectifier circuits in accordance with the present disclosure.

### DETAILED DESCRIPTION

The present disclosure describes various embodiments of systems and related methods for a high efficiency far-field millimeter wave (mmWave)-based wireless power transfer (WPT) using a Cu/Co metaconductor (MC) formed of multiple nanolayered nonmagnetic copper (Cu) and ferromagnetic cobalt (xCo) layers. This marks the first introduction of the MC approach for WPT applications. In various embodiments, the WPT system comprises a transmitter (Tx), receiver (Rx), and rectifier circuit, with components, including the Tx and Rx antennas, as well as the feeding lines and rectifier lines, fabricated using Cu/Co MC. This use of Cu/Co MC offers a remarkable reduction in conductor loss by effectively mitigating the skin effect, leading to a significant enhancement in the overall power transfer efficiency of the WPT system from end to end.

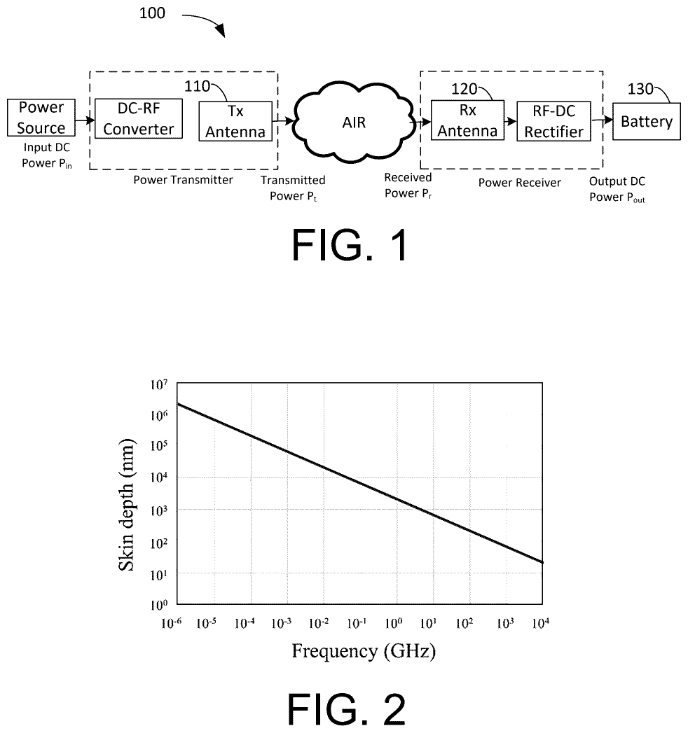

As an initial overview, FIG. 1 shows a block diagram of a radiative WPT system 100. Radiative power emitted from a Tx antenna 110 propagates through the air over a far distance and is captured by an Rx antenna 120 and then converted to DC power and stored to a battery 130. However, the current end-to-end efficiency of radiative far-field WPT systems using state-of-the-art (SOA) component technologies is reported to be between 3-5% which greatly limits the practical implementation of the radiative WPT systems. In addition, as most of conventional radiative WPT systems have used low-giga hertz carrier frequencies, e.g. <3 GHZ, the Tx/Rx antennas are quite big, and often the dimension of a directional antenna becomes a few meters in diameter, making it less practical. Also, the usage of less directive antennas causes the path loss to be significant over the far distance e.g. ˜ km, thereby resulting in low end-to-end efficiency.

To address these issues, millimeter wave (mmWave)-based WPT can be considered. As its wavelength is small (˜ mm), the corresponding antenna size can be reduced. It can also be less dispersive, and its beam directivity can be high, and thus, the path loss can be lowered. It has been proved that mm-Wave-based WPT outperforms WPT with lower frequencies. However, a limiting factor in the use of mmWave for WPT is the significantly high RF conductor loss associated with the skin effect, the tendency of the current flow in the outermost layer of the conductor due to induced eddy current at the high frequency. Equation 1 shows the equation of the skin depth, δ:

$$δ = \sqrt{\frac{2}{σ ω {μ}_{eff}}} \qquad ( 1 )$$

where ω is the angular frequency, μ_{eff} is the effective permeability of the material, and σ is the electrical conductivity. Thus, as the frequency increases, the RF resistance increases and so does the conductor loss, resulting in lowering the overall efficiency. For WPT, both Tx and Rx may use a large array antenna to spread out power for low power density and increase the antenna gain, and thus the loss associated with feeding lines becomes significant. Often the power consumption associated with feeding lines exceeds the power radiated through the antenna elements so that the development of technology for reducing feeding line RF resistance is imperative.

Recent studies have shown that RF devices using metaconductors (MCs) can effectively reduce the conductor loss associated with the skin effect at different frequencies. In 2008, Zhuang et al. reported an RF resistance reduction of 50% at 14 GHz using MC-based coplanar waveguide (CPW) transmission lines consisting of 100 nm Ni₈₀Fe₂₀ and 300 nm Cu multi-layers (total thickness of 6.7 μm) compared to a solid Cu counterpart. See Zhuang, “Magnetic-Multilayered Interconnects Featuring Skin Effect Suppression,” IEEE Electron Device Lett. 29, 319-321 (2008). In 2011, Cu/CoZrNb based MC was reported by Sato et al. to investigate the resistance reduction under 10 GHz range. See Sato, N., et al., “Skin Effect Suppression for Cu/CoZrNb Multilayered Inductor,” J. Appl. Phys., 111 (2011). It was observed that the resistance reduction of 20% can be obtained at 5 GHz utilizing 750 nm Cu/25 nm CoZrNb (total thickness of 6 μm). In addition, Dai et al. have investigated an electroplated Cu/CuCo MC. See Dai, S. et al., “Electrodeposited CoCu/Cu Meta-Conductor with Suppressed Skin Effect for Next Generation Radio Frequency Electronics,” J. of Alloy and Compounds, 778 (2019). By utilizing the alternating 500 nm Cu and180 nm CuCo layers, around 80% resistance reduction was achieved compared with copper counterparts. Although earlier studies have demonstrated MCs utilizing ferromagnetic alloys, e.g. NiFe, CuCo, and CoZrNb, it is frequently difficult to sustain the precise composition of the alloy throughout the fabrication process. Moreover, the previously demonstrated MC-based devices have been difficult to be applied to 5G or mmWave applications as they have shown low RF resistance characteristics only in relatively low frequency bands, i.e. less than 15 GHz. In order to address these issues, low RF resistance materials in mmWave bands have been reported in recent years. Especially, a significant RF resistance reduction between 7 and 32 GHz using Cu/Co based MCs has been successfully demonstrated. More than 50% resistance reduction compared with copper counterparts has been reported with test vehicles of transmission lines and inductors. Because Co has relatively higher magnetic saturation/anisotropy values compared to CoZrNb, NiFe, and CuCo, the reduced RF resistance can be achieved at higher frequencies. In addition, the impact of Cu/Co MCs on a 16-element array antenna has been demonstrated. Due to the low RF resistance of Cu/Co MC compared to the solid Cu, the Cu/Co MC-based antenna has shown a 6 dB improvement in signal reception power compared to the solid Cu counterpart.

In the present disclosure, the efficiency improvement of the mmWave based far-field WPT system using Cu/Co MC is demonstrated. In various embodiments, an operation frequency of the demonstrated WPT system is 28 GHZ, so that a small-sized, light-weighted, and high-gain WPT system can be achieved. In various embodiments, the Tx and Rx antennas, feeding lines, and rectifier lines are fabricated using Cu/Co MC on a low loss glass substrate, thereby decreasing the conductor loss due to the skin effect mitigation, and thus increasing the end-to-end power transfer efficiency of the WPT system.

When operating at direct current (DC), a conductor's entire cross-sectional area is utilized for current flow. However, as for alternating current (AC), when operating frequency increases, eddy currents are produced, causing current to flow only on the surface or “skin” of the conductor (known as the skin effect). As a result, the area of current flow is reduced and the AC resistance increases leading to the occurrence of significant ohmic loss. The skin depth (δ) is the depth at which the current magnitude decreases to approximately 37% of that on the conductor surface. The skin depth can be calculated by using Eq. 1. FIG. 2 depicts the skin depth of a copper wire on a logarithmic frequency scale, indicating that the skin depth consistently decreases as the frequency increases.

The MC approach utilizes non-ferromagnetic and ferromagnetic superlattice structures to suppress the skin effect. From Eq. 1, theoretically, the skin depth can be infinite if the effective permeability of conductor is zero. By using the combination of magnetic and non-magnetic layers, the positive permeability of the non-magnetic materials (μ_{N}) cancels out the negative permeability of the magnetic materials (μ_{F}) between ferromagnetic resonance (FMR) and anti-ferromagnetic resonance (AFMR) frequencies achieving eddy current cancellation, thereby setting the effective permeability of the MC to zero. The effective magnetic permeability (μ_{eff}) of such a multilayer stack-up is given by Equation 2:

$${μ}_{eff} = \frac{{μ}_{N} {t}_{N} + {μ}_{F} {t}_{F}}{{t}_{N} + {t}_{F}} \qquad ( 2 )$$

where t_{N} and t_{F} are the thickness of the non-ferromagnetic and ferromagnetic layer, respectively, and μ_{N} and μ_{F} are the magnetic permeability of the non-ferromagnetic (close to 1) and ferromagnetic layer, respectively. Thus, it is possible to set μ_{eff} to zero by properly selecting the thickness ratio as in Equation 3 (below) when μ_{F}<0 (the negative permeability for a ferromagnetic material) and μ_{N}=1 (for nonferromagnetic material Cᵤ) is satisfied.

From Eq. 2, μ_{eff} for the MC becomes zero when:

$$\vert {μ}_{F} \vert = \frac{{t}_{N}}{{t}_{F}} ( thickness ratio ) \qquad ( 3 )$$

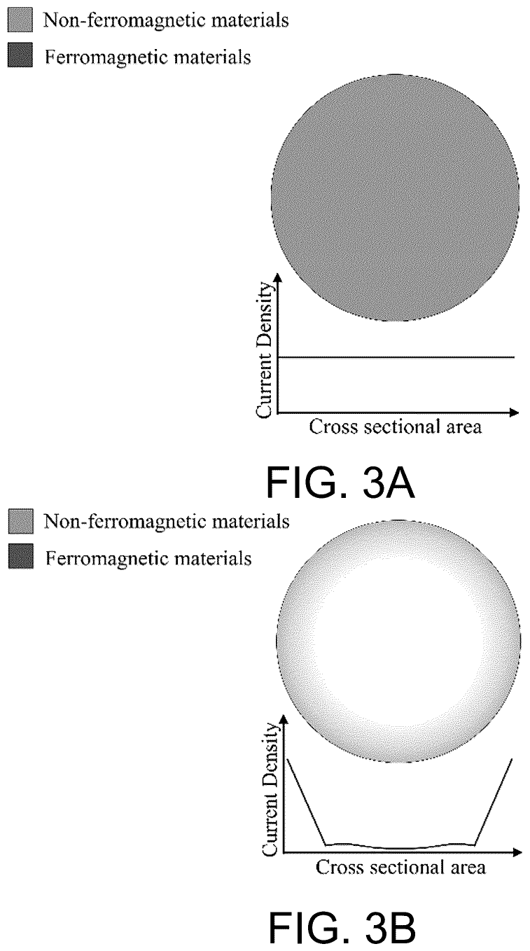

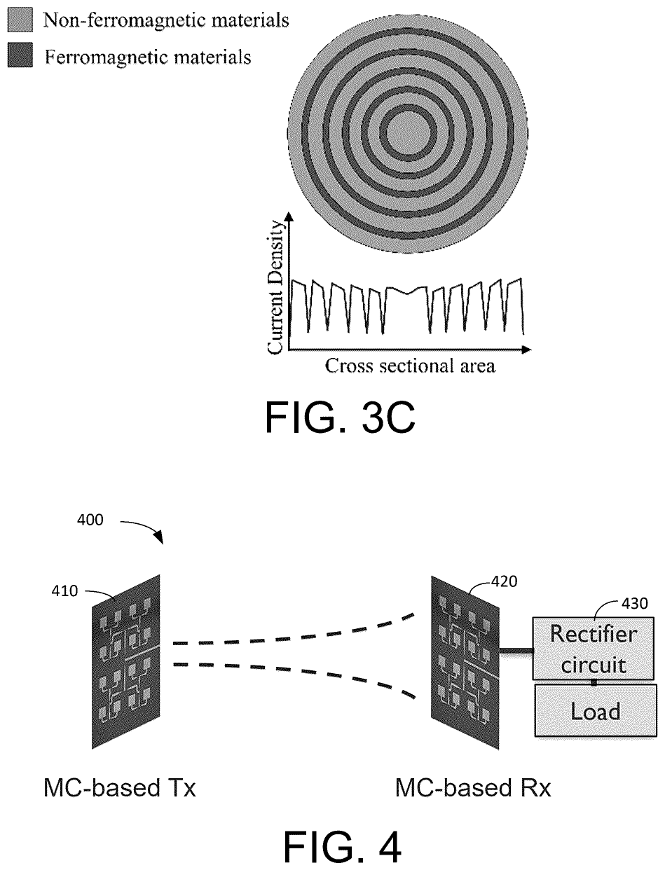

Then, the skin depth of such an MC becomes ideally infinite. FIGS. 3A-3C show the conceptual schematics and current distributions of the normal conductor (e.g., Cu) and the MC at DC and AC. The current distributions in FIGS. 3A-3C are simulated using High Frequency Structural Simulator (HFSS, ANSYS Inc.). At DC, the current density across the total cross-sectional area of the conductor is constant, but at a certain frequency f, the current density is high only at the outer surface with nearly zero current at the center because of the skin effect. As for the MC, the eddy current cancellation occurs and the current can be distributed uniformly inside the MC, resulting in a lower AC resistance compared with its solid normal conductor counterpart.

In preliminary work, a CPW made of 10 pairs of 150 nm Cu/25 nm Co MC has shown a maximum 50% resistance reduction at 28 GHz compared to a solid Cu counterpart. In various embodiments, as the operating frequency of the WPT system is targeted at 28 GHZ, the Cu/Co MC material is chosen to fabricate the WPT system in order to achieve a maximized end-to-end efficiency of the system at 28 GHZ.

A schematic of an exemplary MC-based WPT system 400 is shown in FIG. 4. The MC-based WPT system includes the MC-based Tx 410, Rx 420, and rectifier circuit 430. The radiative power emitted from the MC-based Tx antenna 410 propagates through the air over a far distance and is captured by the MC-based Rx antenna 420 and then converted to DC power by the rectifier circuit 430. In various embodiments, the Tx and Rx antennas, feeding lines, and rectifier lines can be fabricated using Cu/Co MC on a low loss glass substrate, thereby decreasing both the conductor loss and the substrate loss, and thus increasing the gain of the antenna.

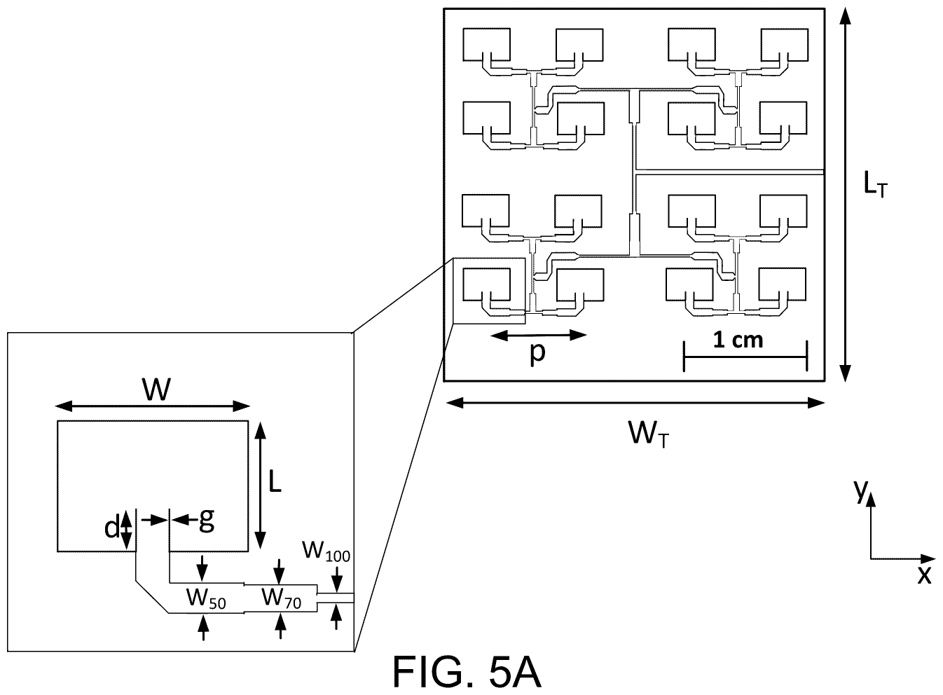

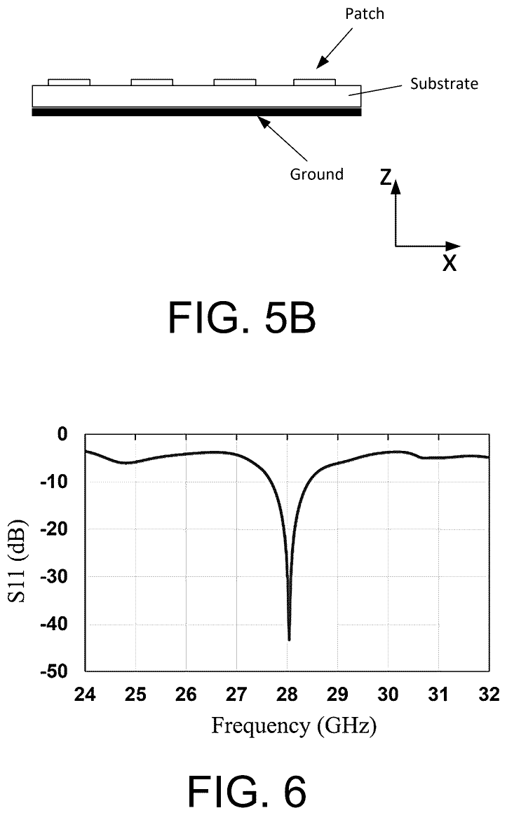

In various embodiments, a 4×4 patch array antenna is selected for the Tx and Rx design due to the high performance, narrow bandwidth, compactness, and easy installation with other integrated circuits. The Tx and Rx can be designed on a 0.3 mm thick Corning SG 3.4 glass substrate (8=5.14, 0=0.0038 at 24 GHZ) instead of the printed circuit board to minimize the substrate loss. FIGS. 5A-5B show exemplary schematic diagrams of the Tx and Rx, where W_{T}=50 mm, L_{T}=50 mm, W=3.07 mm, L=2.27 mm, d=0.95 mm, g=0.07 mm, W₅₀=0.506 mm, W₇₀=0.253 mm, W₁₀₀=0.09 mm, and p=6.9 mm. The patch dimensions, W and L, are set for the operation frequency (28 GHZ). The inset gap and feeding distance are optimized for impedance matching (50Ω). In order to distribute the power to the patch elements equally, a 3 dB power divider using quarter wave transformers is utilized. The distance between patches is carefully optimized in order to decrease the coupling between patches and suppress the grating lobes.

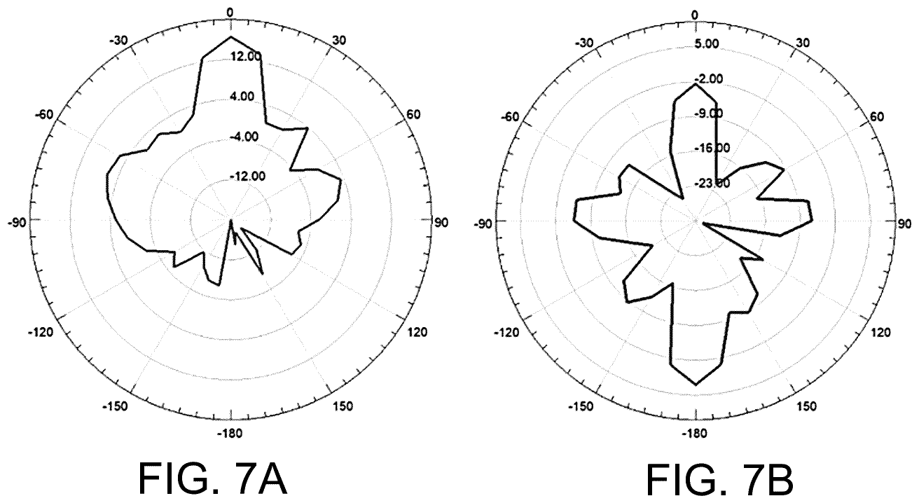

Correspondingly, FIG. 6 shows the simulated results of the Tx and Rx. The simulated S11 shows that the designed Tx and Rx work at 28 GHZ and the 10 dB bandwidth is shown to be 0. 78 GHz. FIGS. 7A-7B show the simulated radiation patterns of the Tx and Rx in the YZ plane and the XZ plane. The simulated peak gain of the Tx and Rx is 16.43 dBi.

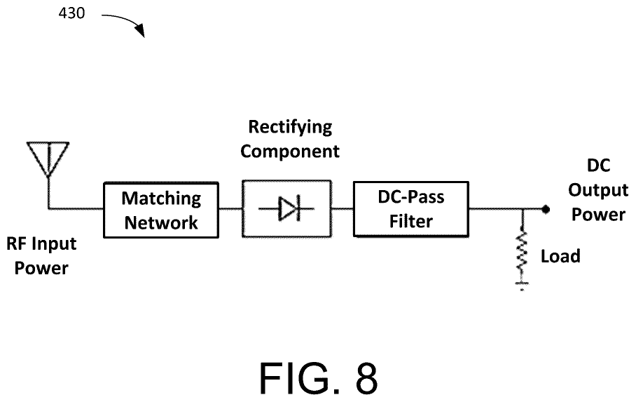

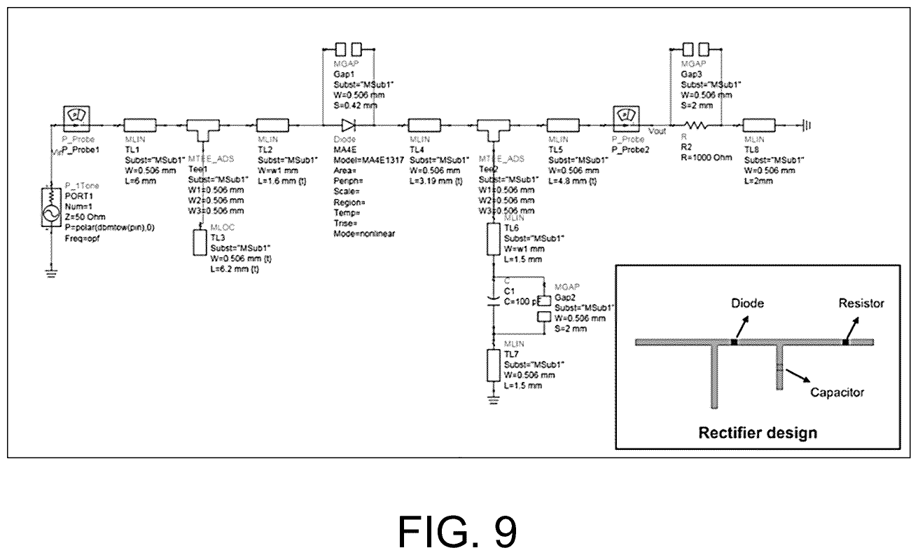

FIG. 8 shows an exemplary block diagram of the rectifier circuit 430. In various embodiments, a designed rectifier includes the matching circuit, rectifying component, DC-pass filter, and load. In the present disclosure, the rectifier design is simplified in order to investigate the effect of the MC on the rectifier performance. FIG. 9 shows the schematic of the rectifier circuit in Advanced Design System (ADS, Keysight Inc.). The rectifier is designed to have maximum RF-DC conversion efficiency at the input power of 10 dBm. In various embodiments, the rectifier circuit contains a Schottky diode (MA4E1317, MACOM Inc.), low-pass filter (100 pF shunt capacitor), and a resistive load (1,000 ohms). In general, it is known that the MA4E1317 diode could perform effectively up tot 80 GHz with high conversion efficiency (>40%) if the mmWave rectifier is properly designed. The SPICE model of MA4E1317 is utilized for the ADS simulation. The value of the components are optimized for the operation frequency (28 GHz) and power level (10 dBm) in this rectifier design. The rectifier circuit is matched to 50 ohms since the input impedance of the Rx is 50 ohms. The detailed simulation results of the rectifier circuit are further discussed with the measurement results.

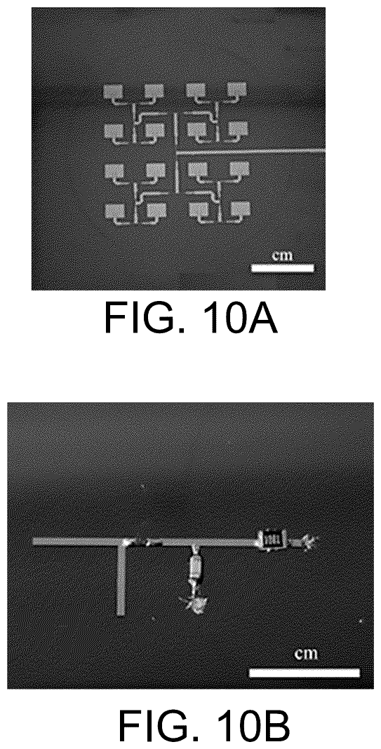

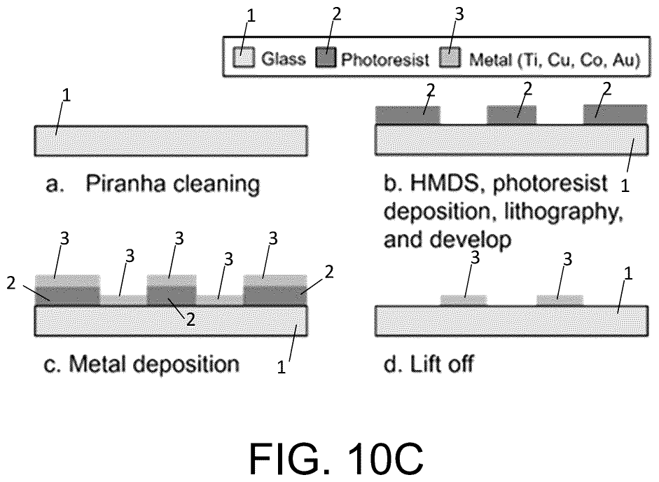

As shown in FIGS. 10A-10B, a prototype of the Cu/Co MC-based WPT system is fabricated on a low loss glass substrate instead of the printed circuit board to minimize the substrate loss. As for the fabrication of the rectifier circuit, the Schottky diode (MA4E1317, MACOM Inc), 1,000 ohms resistor (RNCP0603FTD1K00, Stackpole Electronics Inc.), and 100 pF capacitor (GCM1885G2A101FA16D, Murata Electronics Inc.) are selected.

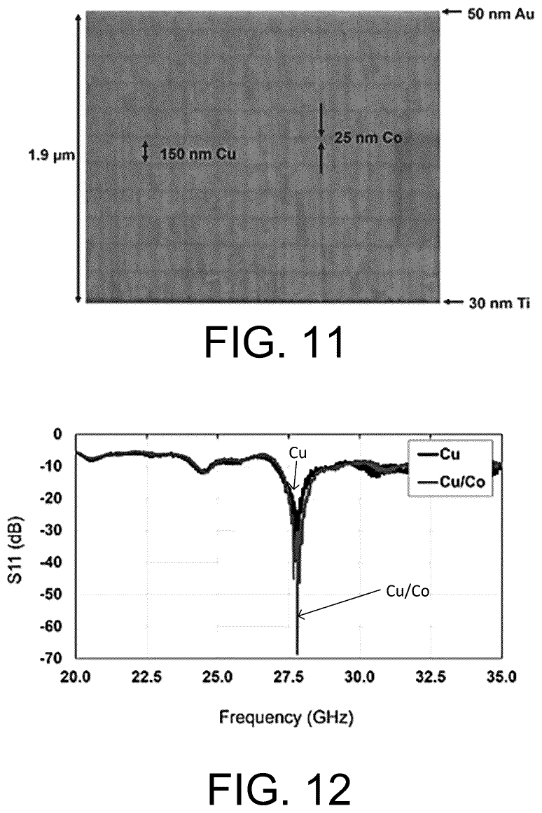

FIG. 10C shows an exemplary fabrication process of the prototypes of FIGS. 10A-10B. In various embodiments, the glass substrate is piranha cleaned (act a) and the hexamethyldisilazane (HMDS) is coated on the substrate to enhance the adhesion of the photoresist. Then, photoresist (NR9 8000, Futurrex Inc.) is patterned (act b) and the thin metal layers are deposited using sputtering technique. First, 30 nm titanium (Ti) layer is sputtered as an adhesion promotion layer between the Cu and substrate. Then, 10 pairs of alternating Cu/Co (150 nm/25 nm), Cu (100 nm), and Au (50 nm) are deposited (act c). Finally, the lift-off process is performed in acetone to remove the metal on the photoresist (act d). In addition, the solid Cu-based WPT system is fabricated with the same total thickness (1.93 μm) as the Cu/Co MC-based one for the performance comparison. FIG. 11 shows a scanning electron microscope image of a cross section view of the Cu/Co MC layers for the fabricated material used in the WPT system. It is clearly shown that the alternating Cu and Co layers are uniformly deposited.

Simulations of the Tx and Rx antennas are performed in High Frequency Structural Simulator (HFSS, ANSYS Inc.). Because of limitations on the memory size to solve the extremely high aspect ratio multi-layer Cu/Co MC, only Cu-based Tx and Rx antennas are simulated in HFSS. Also, Advanced Design System (ADS, Keysight Inc.) has been utilized for the simulation of the rectifier circuit.

For the Tx and Rx measurement, a vector network analyzer (HP E8361A, Agilent, Inc.) is utilized. Single port measurements are carried out for the S11 measurement. The measured S11 in FIG. 12 shows that the resonance frequencies of the Cu and Cu/Co MC-based antennas are 27.76 GHZ and 27.82 GHZ, respectively, which are well matched with the simulated resonance frequency (28 GHZ) in FIG. 6. It is observed that 10 dB bandwidths of the Cu and Cu/Co MC-based antennas are 2.03 GHZ and 2.18 GHz, respectively.

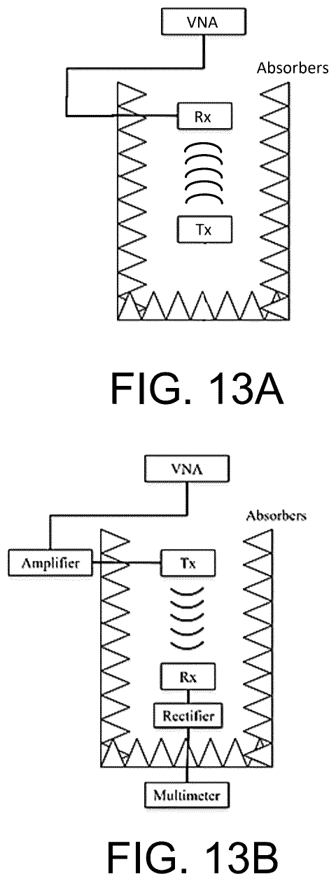

In addition, the transmission efficiencies of the Cu and Cu/Co MC-based WPT systems are measured using a vector network analyzer. FIGS. 13A and 13B show the measurement setups. In order to minimize the interference, a semi-anechoic condition is set up for the measurement by surrounding RF absorbers, as illustrated in FIGS. 13A and 13B. For the Tx and Rx measurement, a vector network analyzer (HP E8361A, Agilent, Inc.) is utilized. Single port measurements are carried out for the S11 measurement. Then, the transmission efficiencies of the Cu and Cu/Co MC-based WPT systems are measured using the same vector network analyzer. The Tx and Rx antennas are connected to the two ports of the VNA. Then, the S21 is extracted. Lastly, the system efficiencies of WPT systems are measured. FIG. 13B shows the measurement setup which features vector network analyzer (HP E8361A, Agilent, Inc.), 30 dB power amplifier (PE15A3266, Pasternack Inc), Tx antenna, Rx antenna, rectifier, and multimeter (Fluke 189). In the measurement, the fabricated Tx antenna has been utilized to provide wireless microwave power (28 GHz). The Rx antenna is placed at a distance of 20 cm away from the Tx antenna which satisfies the far-field condition at 28 GHZ (R≥2D²/λ=10.6 cm, where D is the largest dimension of the aperture of the antenna and A is the free-space wavelength at the operating frequency).

For the WPT system, the transfer efficiency can be explained as the ratio of the received power at the Rx (port 2) to the inserted power at the Tx (port 1), so that the transfer efficiency, η_{T}, can be directly calculated using Equation 4:

η_{T}=|S₂₁|²×100% (4)

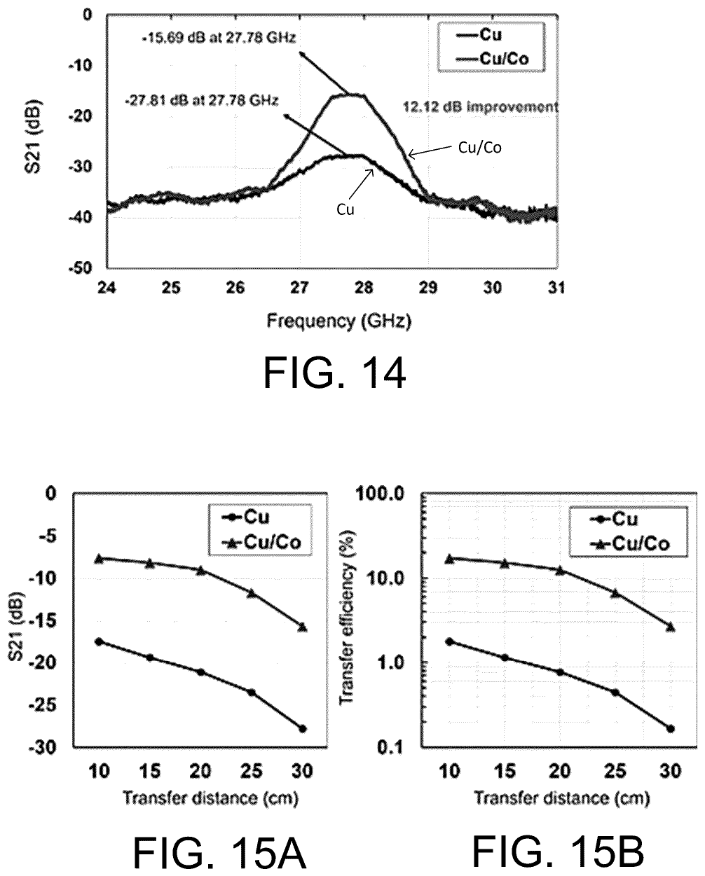

FIG. 14 shows the measured S21 at a distance of 30 cm. The measured results exhibit that the Cu/Co MC-based WPT system shows a 12.12 dB improvement in reception power level compared with Cu-based counterparts. This leads to a factor of 16.22 improvement in the linear scale. In addition, the transfer coefficients and transfer efficiencies of the Cu and Cu/Co MC-based WPT system are measured with the varied transfer distance (10 ˜ 30 cm). It is worth noting that the S21 and transfer efficiencies of the Cu/Co MC-based WPT system are improved significantly for entire transfer distances as shown in FIGS. 15A-15B. It is proved that the utilization of the Cu/Co MC and low loss glass substrate decreases the conductor loss and substrate loss, thus increasing the gain of the antenna and transfer efficiency of the WPT system.

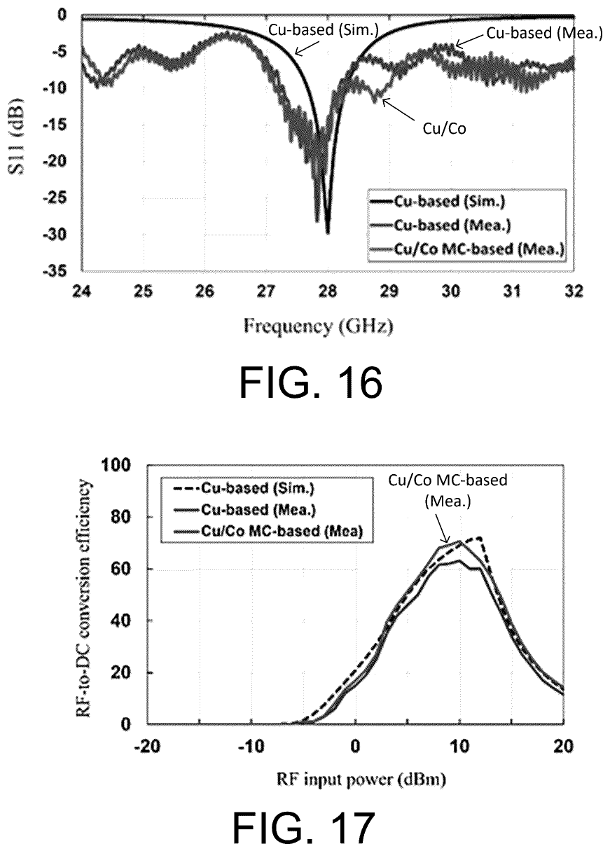

Single port measurements are carried out for the S11 measurement. FIG. 16 shows the simulated and measured S11 of the rectifier circuit. Good agreement between simulation and measurement confirms the accuracy of the method used in matching the rectifier's input impedance.

Then, the RF-to-DC conversion efficiency of the rectifier circuit is measured and characterized (using the measurement setup of FIG. 13B). The RF-to-DC conversion efficiency of the rectifier can be obtained using Equation 5:

$${η}_{RF - DC} = \frac{{P}_{out}}{{P}_{in}} \times 100 ( \% ) = \frac{{V}_{DC}^{2}}{{P}_{in} {R}_{L}} \times 100 ( \% ) \qquad ( 5 )$$

where Pᵢₙ is the RF input power, Pₒᵤₜ is the output DC power, R_{L} is the load resistance, and V_{DC} is the DC voltage across the load. To obtain practical measurement results, a rectifier is connected to the Rx to measure the RF-DC efficiency. FIG. 17 shows the simulated and measured RF-to-DC conversion efficiencies of the Cu and Cu/Co MC-based rectifier circuits as a function of the RF input power. The Cu/Co MC-based rectifier exhibits enhanced RF-to-DC conversion efficiency for input power, indicating that the utilization of the Cu/Co decreases the conductor loss, thus improving the RF-to-DC conversion efficiency. Especially, the measured RF-to-DC conversion efficiency of the Cu/Co MC-based rectifier at 10 dBm is improved from 63.7% to 70.6% compared with that of the solid Cu counterpart.

The system efficiency of the WPT system, ηₜₒₜₐₗ, can be calculated by using Equation 6:

$${η}_{sys} = {η}_{DC - RF} \times {η}_{T} \times {η}_{RF - DC} . \qquad ( 6 )$$

A comparison of the WPT system efficiency (η_{sys}) of the Cu/Co MC-based WPT system with the solid Cu counterpart is provided in Table 1 (below). As for η_{DC-RF}, known achievable efficiency is approximately 85%, varying with conversion method and implementation. Thus, η_{DC-RF} of the Cu and Cu/Co MC-based WPT system is assumed to be 85% for the comparison purpose. From Table 1, it is clearly shown that the entire WPT system efficiency of the Cu/Co MC-based WPT system is improved from 0.42% to 7.5% compared with the Cu-based one. This represents a significant WPT system efficiency improvement of 17.85 times, demonstrating that utilizing Cu/Co MC in WPT is highly superior to the usage of Cu only in terms of energy efficiency.

TABLE 1

| Reference | η_{DC-RF} | η_{T} | η_{RF-DC} | η_{sys} |
|---|---|---|---|---|
| Cu-based WPT | 85% | 0.77% | 63.7% | 0.42% |
| (4 × 4) | (Exp.) | (Mea.) | (Mea.) | |
| Cu/Co MC-based WPT | 85% | 12.51% | 70.6% | 7.5% |
| (4 × 4) | (Exp.) | (Mea.) | (Mea.) | |

Also, additional simulations have been conducted to investigate how many arrays of the Cu-based Tx (or Rx) antenna are needed to achieve comparable efficiency as the MC-based WPT. A simulated peak gain of 21.17 dBi can be achieved with the Cu-based antenna (8×8) which has a dimension of 54.5×54.5 mm². On the other hand, the Cu/Co MC-based antenna (4×4) shows a measured peak gain of 21.72 dBi and a dimension of 23.8×23.8 mm². This means that the Cu/Co MC-based antenna (4×4) has almost the same antenna gain as the Cu-based antenna (8×8), but the size of the Cu/Co MC-based antenna (4×4) is only 19% of the Cu-based antenna (8×8) size. It is proved that the utilization of Cu/Co MC in WPT applications has great advantages in terms of size, weight, and efficiency, which would be highly useful for portable and space applications.

In the present disclosure, a high efficiency far-field millimeter (mm) wave-based WPT system is demonstrated using a Cu/Co metaconductor (MC) formed of multiple nanolayered nonmagnetic copper (Cu) and ferromagnetic cobalt (Co). This marks the first introduction of the MC approach for WPT applications. The WPT system includes Tx, Rx, and rectifier circuits. The Tx and Rx antennas, feeding lines, and rectifier lines are fabricated using Cu/Co MC on a low loss glass substrate, thereby decreasing both the conductor loss and the substrate loss, and thus increasing the end-to-end efficiency of the WPT system. The prototype of the Cu/Co MC-based WPT system is designed, fabricated, and characterized. Also, the solid Cu-based WPT system is fabricated with the same thickness as the Cu/Co MC-based one for the performance comparison. It is shown that the entire WPT system efficiency of the Cu/Co MC-based WPT system is improved from 0.42% to 7.5% compared with the Cu-based one at a distance of 20 cm. This represents a significant WPT system efficiency improvement of 17.85 times, demonstrating that utilizing Cu/Co MC in WPT is highly superior to the usage of Cu in terms of energy efficiency. Moreover, it is shown that a size and weight reduction of 81% could be obtained by utilizing MC in WPT applications without performance degradation. It is highly expected that the Cu/Co MC-based WPT system will provide new possibilities for WPT applications with reduced size and decreased weight, and improved efficiency in portable and space applications.

In a non-limiting implementation, the present disclosure demonstrates a 4×4 array antenna/rectenna configuration, showcasing a substantial 17.5 times improvement in gain with the use of Cu/Co metaconductor compared to a solid Cu counterpart. The array configuration provides high-efficiency power transfer for the wireless power transfer system. Gain is notably enhanced with a greater number of antenna elements. Even higher contrasts in gain are anticipated by increasing the number of elements in the array. To further elucidate the scalability of the present technology, transitioning to an 8×8 array and n×n antenna design is contemplated.

To compare its performance, a solid Cu-based WPT system was fabricated with an equivalent total metal thickness to that of the Cu/Co MC-based WPT system. In experimental analysis, the Cu/Co MC-based WPT system clearly demonstrates superior performance over the solid Cu-based system at a distance of 20 cm. The power transfer efficiency shows a remarkable increase from 0.42% to 7.5%, resulting in a notable 17.85-fold improvement with the Cu/Co MC-based WPT system compared to its solid Cu-based counterpart. Furthermore, the MC-based WPT technology enables an impressive 81% reduction in size and weight without any compromise in performance. These advancements hold great promise for various WPT applications, particularly in portable and space-related contexts. With its reduced size, decreased weight, and improved efficiency, the Cu/Co MC-based WPT system is expected to open up new possibilities and opportunities for a wide range of applications.

As a non-limiting example, this technology can be utilized in the exploration of Simultaneous Wireless Information and Power Transfer (SWIPT) at 28 GHz (or higher including 35 GHz, 60 GHz, 94 GHz bands, etc.). The advantages of 28 GHz wireless power transfer, particularly its integration with wireless signal communications, position the disclosed systems and methods at the forefront of realizing 5G SWIPT at 28 GHz. The power level of wireless information (or signal) transmission is micro to milliwatt range. By increasing the power range of the career electromagnetic wave e.g. 28 GHZ, the system can simultaneously deliver information and power. In the disclosed system, the efficiency of the antenna and associated components is important. The metaconductor based high efficiency antennas, transmission lines, and passive components will greatly benefit highly energy efficient SWIFT systems. The integration of SWIPT and a Cu/Co metaconductor based antenna can lead to the optimization of energy efficiency concerning power consumption. This optimization is achieved by facilitating the simultaneous transmission of both power and information and can be utilized to deliver power and information to remote distributed sensors for Internet of Things (IoT) including agriculture sensors, environments sensors, and transportation sensors, where battery replacement may not be convenient. Thus, the inclusion of SWIPT at 28 GHz introduces a new dimension to the practical applications of the disclosed metaconductor. Accordingly, the seamless integration with wireless signal communications aligns the disclosed technologies with the evolving landscape of 5G technology, thereby contributing significantly to the field of sustainable electronics.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

It is also understood that this disclosure is not limited to the specific devices, methods and conditions or parameters described and/or shown herein, and that the terminology used herein is for the purpose of describing particular embodiments by way of example only and is not intended to be limiting of the claimed disclosure. Also, as used in the specification including the appended claims, the singular forms “a,” “an,” and “the” include the plural, and reference to a particular numerical value indicates at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Unless defined otherwise, all technical and scientific terms used herein have the same meaning as commonly understood by one of ordinary skill in the art to which this disclosure belongs.

Therefore, at least the following is claimed:

1. A wireless power transfer system comprising:
a transmitter antenna configured to transmit a radiative power signal;
a receiver antenna configured to capture the transmitted radiative power signal; and
a rectifier circuit coupled to the receiver antenna and configured to convert the captured radiative power signal to DC power,
wherein the transmitter antenna, the receiver antenna, and the rectifier circuit are each formed of a combination of ferromagnetic and non-ferromagnetic conductors in alternating multilayers.

2. The system of claim 1, wherein the ferromagnetic conductor is cobalt and the non-ferromagnetic conductor is copper.

3. The system of claim 1, wherein for each of the transmitter antenna, the receiver antenna, and the rectifier circuit, the combination of ferromagnetic and non-ferromagnetic conductors is positioned between titanium and copper layers, wherein the copper layer is positioned below a gold layer and the titanium layer is formed on a glass substrate.

4. The system of claim 1, wherein the combination of ferromagnetic and non-ferromagnetic conductors in alternating multilayers comprises 10 pairs of alternating layers of cobalt and copper.

5. The system of claim 1, wherein the transmitter antenna comprises a 4×4 patch array antenna.

6. The system of claim 1, wherein the receiver antenna comprises a 4×4 patch array antenna.

7. The system of claim 1, wherein the transmitter antenna comprises an 8×8 patch array antenna.

8. The system of claim 1, wherein the receiver antenna comprises an 8×8 patch array antenna.

9. The system of claim 1, wherein the transmitter antenna and the receiver antenna are separated by a transfer distance between 10 cm and 30 cm.

10. The system of claim 1, wherein the system operates at approximately 28 GHZ.

11. A wireless power transfer method comprising:
transmitting a radiative power signal using a transmitter antenna;
capturing the transmitted radiative power signal with a receiver antenna; and
convert the captured radiative power signal to DC power using a rectifier circuit coupled to the receiver antenna,
wherein the transmitter antenna, the receiver antenna, and the rectifier circuit are each formed of a combination of ferromagnetic and non-ferromagnetic conductors in alternating multilayers.

12. The method of claim 11, wherein the ferromagnetic conductor is cobalt and the non-ferromagnetic conductor is copper.

13. The method of claim 11, wherein for each of the transmitter antenna, the receiver antenna, and the rectifier circuit, the combination of ferromagnetic and non-ferromagnetic conductors is positioned between titanium and copper layers, wherein the copper layer is positioned below a gold layer and the titanium layer is formed on a glass substrate.

14. The method of claim 11, wherein the combination of ferromagnetic and non-ferromagnetic conductors in alternating multilayers comprises 10 pairs of alternating layers of cobalt and copper.

15. The method of claim 11, wherein the transmitter antenna comprises a 4×4 patch array antenna.

16. The method of claim 11, wherein the receiver antenna comprises a 4×4 patch array antenna.

17. The method of claim 11, wherein the transmitter antenna comprises an 8×8 patch array antenna.

18. The method of claim 11, wherein the receiver antenna comprises an 8×8 patch array antenna.

19. The method of claim 11, wherein the transmitter antenna and the receiver antenna are separated by a transfer distance between 10 cm and 30 cm.

20. The method of claim 11, wherein the system operates at approximately 28 GHz.
